(19) United States
(12) Patent Application Publication
(10) Pub. No.: US 2009/0037165 A1
(43) Pub. Date: Feb. 5, 2009

(54) Method and Apparatus for Processing Transactions in a Simulation Environment

(76) Inventors: Thomas Michael Armstead, Rochester, MN (US); John Hubert Klaus, Rochester, MN (US); Paul Emery Schardt, Rochester, MN (US); Scott Michael Willenborg, Stewartville, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/830,147

(22) Filed: Jul. 30, 2007

(51) Int. Cl. G06F 9/45

(52) U.S. Cl. 703/22

(57) ABSTRACT

A method, article of manufacture and apparatus for simulating a plurality of transactions. A first group of transactions with first simulation properties are provided and a second group of transactions with second simulation properties are provided. The first simulation properties are different from the second simulation properties. During software simulation of a hardware model, the first group of transactions and the second group of transactions are issued to the hardware model. The first group of transactions and the second group of transactions are processed using the hardware model. At least a portion of the first group of transactions and the second group of transactions is processed simultaneously using the hardware model. The first simulation properties are used to process the first group of transactions using the hardware model and wherein the second simulation properties are used to process the second group of transactions using the hardware model.

### BACKGROUND OF THE INVENTION

Modern computer systems are increasingly complex. As modern computer systems become increasingly complex, design and testing of such computer systems also becomes increasingly complex. For example, in some cases, design and testing of computer systems may be performed by describing the computer system using a computer language such as a hardware description language (HDL). The hardware description language may describe different components of the computer system and may in some cases indicate how those components operate with one another.

Computer systems described using a hardware description language may be tested in a software simulator which simulates operation of the computer system using test transactions. The simulator may simulate processing of the test transactions using the description of the computer system. Test results of the simulation may then be compared to expected results to determine if the described computer system is operating as desired. If the test results do not match the expected results, then the design of the computer system may be analyzed to determine the source of the error.

Managing the complexity of computer system testing increases where a computer system (or multiple computer systems) being tested performs multiple transactions simultaneously. In some cases, due to the complexity of the computer system, accurate testing of the computer system may be inhibited due to the complexity of the computer system being tested. Accordingly, what is needed is an improved method and apparatus for testing a computer system.

### SUMMARY OF THE INVENTION

Embodiments of the present invention generally provide a method, system, and computer-readable medium for simulating transactions. The method includes providing a first group of transactions with first simulation properties and providing a second group of transactions with second simulation properties. The first simulation properties are different from the second simulation properties. During software simulation of a hardware model, the first group of transactions and the second group of transactions are issued to the hardware model. The first group of transactions and the second group of transactions are processed using the hardware model. At least a portion of the first group of transactions and the second group of transactions is processed simultaneously using the hardware model. The first simulation properties are used to process the first group of transactions using the hardware model and the second simulation properties are used to process the second group of transactions using the hardware model.

One embodiment of the invention provides a computer readable storage medium containing a program which, when executed, performs an operation. The operation includes providing a first group of transactions with first simulation properties and providing a second group of transactions with second simulation properties. The first simulation properties are different from the second simulation properties. During software simulation of a hardware model the first group of transactions and the second group of transactions are issued to the hardware model. The first group of transactions and the second group of transactions are processed using the hardware model. At least a portion of the first group of transactions and the second group of transactions is processed simultaneously using the hardware model. The first simulation properties are used to process the first group of transactions using the hardware model and wherein the second simulation properties are used to process the second group of transactions using the hardware model.

One embodiment of the invention provides a system. The system includes a processor and a computer readable storage medium containing a program which, when executed by the processor, performs an operation. The operating comprises providing a first group of transactions with first simulation properties and providing a second group of transactions with second simulation properties. The first simulation properties are different from the second simulation properties. During software simulation of a hardware model, the first group of transactions and the second group of transactions are issued to the hardware model. The first group of transactions and the second group of transactions are processed using the hardware model. At least a portion of the first group of transactions and the second group of transactions is processed simultaneously using the hardware model. The first simulation properties are used to process the first group of transactions using the hardware model and the second simulation properties are used to process the second group of transactions using the hardware model.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram depicting a computer system according to one embodiment of the present invention.

FIG. 2 is a block diagram depicting groups of transactions according to one embodiment of the invention.

FIG. 3 is a flow diagram depicting a process for processing transactions in a simulation environment according to one embodiment of the invention.

FIG. 4 is a flow diagram depicting a process for using simulation properties to generate and process grouped transactions according to one embodiment of the invention.

### DETAILED DESCRIPTION OF THE PREFERRED EMBODIMENTS

Embodiments of the present invention generally provide a method and apparatus for simulating a plurality of transactions. The method includes providing a first group of transactions with first simulation properties and providing a second group of transactions with second simulation properties. The first simulation properties are different from the second simulation properties. During software simulation of a hardware model, the first group of transactions and the second group of transactions are issued to the hardware model. The first group of transactions and the second group of transactions are processed using the hardware model. At least a portion of the first group of transactions and the second group of transactions is processed simultaneously using the hardware model. The first simulation properties are used to process the first group of transactions using the hardware model and wherein the second simulation properties are used to process the second group of transactions using the hardware model. By placing transactions into separate groups, control of simulation and testing of the hardware model using the transactions may be improved. For example, by modifying the respective properties of the first group of transactions and the second group of transactions, each group of transactions may be used to test different aspects of the hardware model, as described below.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer- readable storage media include, but are not limited to: (i) non-writable storage media (e.g., read-only memory devices within a computer such as CD-ROM disks readable by a CD-ROM drive, DVDs readable by a DVD player, etc.) on which information is permanently stored; (ii) writable storage media (e.g., floppy disks within a diskette drive, a hard-disk drive, volatile and non-volatile memory such as flash or dynamic random access memory, etc.) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

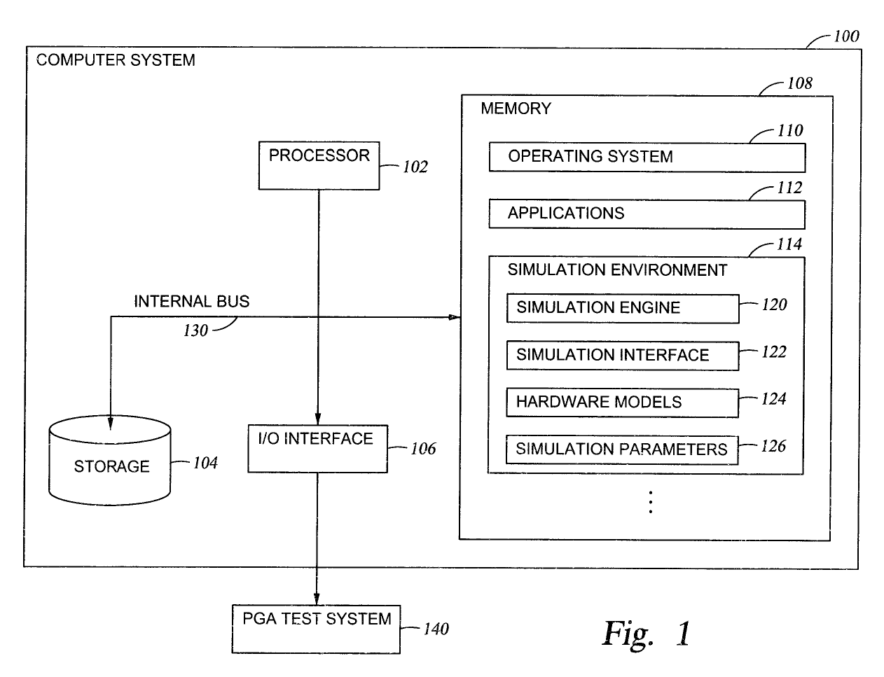

FIG. 1 is a block diagram depicting a computer system 100 according to one embodiment of the invention. The computer system 100 may include a processor 102, storage 104, input/output (I/O) interface 106, and memory 108, each connected by an internal bus 130. During operation of the computer system 100, programs and data may be loaded from storage 104 and placed in the memory 108. Programs in the memory 108 may be executed by the processor 102. Programs executed by the processor 102 may include an operating system (O/S) 110, applications 1 12, and programs for a simulation environment 114.

In one embodiment, the simulation environment 114 may be used to test and validate hardware models 124. By using the simulation environment 114 to test and validate models 124 of hardware devices, any defects in the hardware devices may be detected before the hardware devices are manufactured, thereby ensuring proper operation of the manufactured hardware devices. The simulation environment 114 may include a simulation engine 120 for simulating operation of the models 124, a simulation interface 122 for obtaining input from a user of the computer system 100 and for providing results and other feedback to the user, and simulation parameters 126 which may be selected by the user to control how a simulation is performed. The hardware models 124 used for simulation may be described in a hardware description language (HDL) such as VHDL, Verilog, or any other appropriate language such as the C or C++ programming language.

In one embodiment of the invention, a simulation (or a portion of a simulation) may be performed using a programmable gate array (PGA) test system 140 or other corresponding programmable logic device. For example, hardware models 124 may be written to the PGA test system 140 where the PGA test system 140 may implement the models 124 using programmable logic. The I/O interface 106 may be used to write the models 124 to the PGA test system 140, initiate a test of the models 124, and obtain feedback regarding the test from the PGA test system 140.

In one embodiment of the invention, simulation and testing of the hardware models 124 may be performed by generating and issuing transactions to the hardware model 124. Processing of the transactions may then be simulated using the simulation environment 114. The transactions may include, for example, packets issued from a device in the hardware model 124 to another device in the hardware model 124. The packets may include commands and/or data to be processed by devices in the hardware model 124. The packets may also include source and destination addresses and/or one or more group identification numbers identifying a group to which a packet belongs. One example of hardware that may be modeled and tested using groups of transactions described herein is a hub chip which may communicate with devices external to a computer system via a first interface and with the internal memory of the computer system via a second interface. In one embodiment, the first interface may be an InfiniBand interface.

In some cases, to provide realistic simulation of the hardware model 124, multiple transactions may be processed simultaneously using the hardware model 124. Thus, the hardware model 124 may be used to simulate processing of multiple packets simultaneously. As previously indicated, managing the complexity of testing of a hardware model 124 may increase where the hardware model 124 (or multiple hardware models) being tested is used to perform multiple transactions simultaneously.

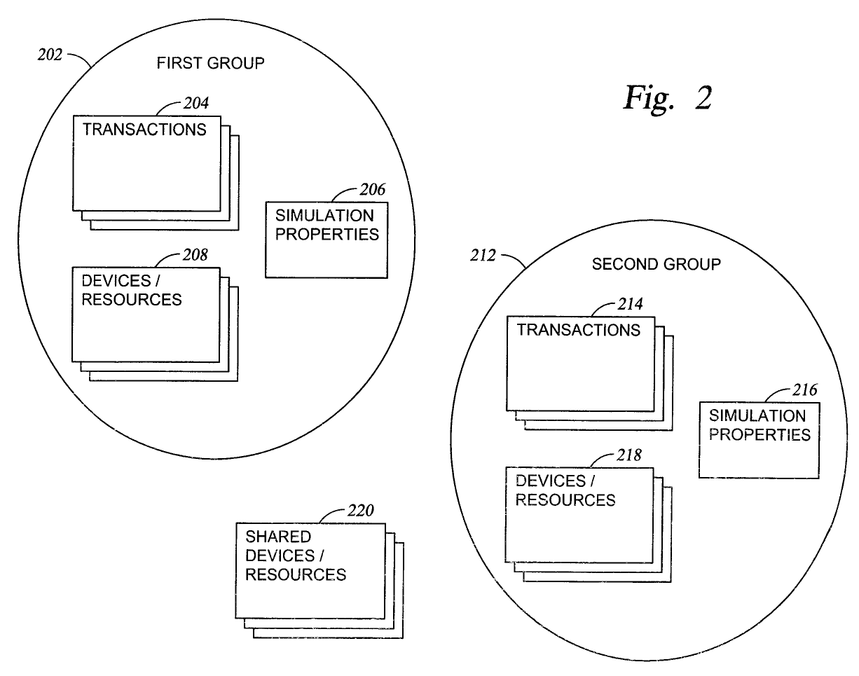

In one embodiment of the invention, the complexity of testing the hardware model 124 may be managed by grouping transactions together as depicted in FIG. 2. As depicted, transactions 204, 214 may be placed in a first group 202 and a second group 212. The group 202, 212 to which a transaction 204, 214 belongs may be identified, for example, by a group identification number assigned to the transaction 204, 214. As described below, first simulation properties may be provided for the first group 202 of transactions 204 and second simulation properties 216 may be provided for the second group 212 of transactions 214. In general, the transaction grouping and simulation properties 206, 216 may be used to control or identify any properties of transactions 204, 214 and/or devices 208, 218 in a given group 202, 212. For example, the simulation properties 206, 216 may be used to control what types of transactions 204, 214 are issued and also to control error injection, checking, error recovery, and other properties for the respective transactions 204, 214. In some cases, simulation properties for a transaction may be applied by modifying attributes of a given programming object representing a transaction 204, 214.

In some cases, to further manage simulation of transaction processing, the transactions 204, 214 may be grouped together with devices or resources 208, 218 which are used to process the respective transactions 204, 214. The grouped devices/resources 208, 218 may include transaction generators configured to generate the transactions 204, 214, transaction processing devices configured to process the transactions 204, 214, and/or control devices configured to monitor and control performance of other devices. The grouping of devices/resources 208, 218 may be used, for example, to control generation of transactions using those devices/resources 208, 218 as well as processing, error checking, and error recovery performed with those devices/resources 208, 218 while processing the transactions 204, 214. In some cases, devices/resources 208, 218 and transactions 204, 214 from both groups 202, 212 may also interact with shared devices/resources 220 such as a shared memory.

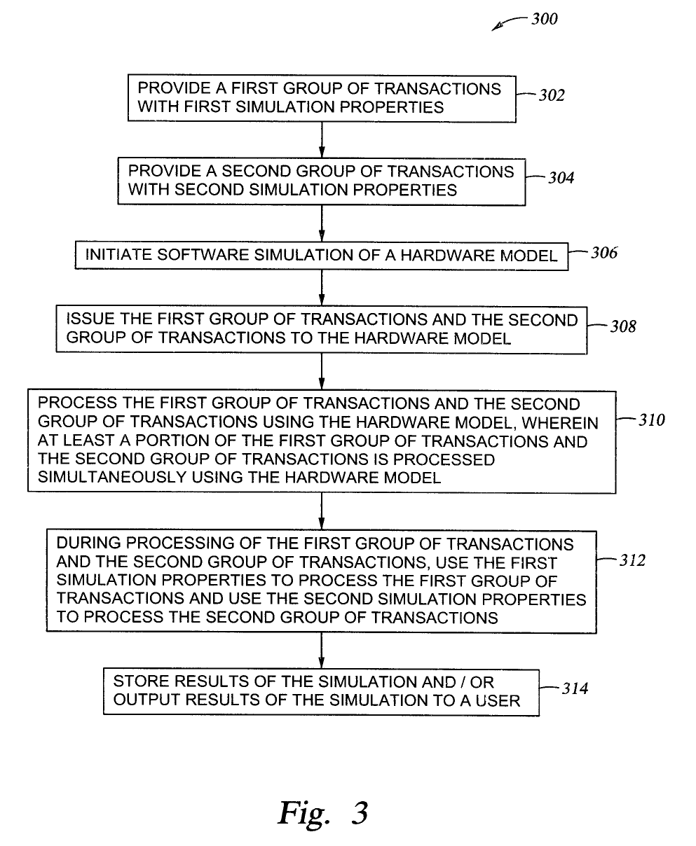

FIG. 3 is a flow diagram depicting a process 300 for simulating transactions according to one embodiment of the invention. As depicted, the process 300 begins at step 302 where a first group of transactions with first simulation properties is provided. Then, at step 304, a second group of transactions with second simulation properties is provided. In one embodiment, the groups of transactions 204, 214 may be predefined, for example, as part of the files of the simulation environment 114. Optionally, in one embodiment, the transactions 204, 214 may be generated and grouped in response to a request from a user. Similarly, the simulation properties 206, 216 may in some cases be predefined or may be selected and/or modified in response to a request from a user. Such modifications may be made, for example, using the simulation interface 122.

Also, in some cases, the transactions 204, 215 may be generated and placed in one of the groups 202, 212 during simulation and testing of the hardware models 124. For example, one of the devices 208, 218 in the groups 202, 212 may be configured to generate the transactions 204, 214 according to the simulation properties 206, 216 during simulation and testing. In such a case, the simulation properties 206, 216 may indicate the number of transactions, the type of transactions, and/or other properties of the transactions being generated. Furthermore, devices which generate the transactions may also be configured to randomly or pseudo- randomly generate transactions. For example, the time at which a transaction is generated, the number of transactions generated, and/or the types of transaction generated may be randomized, and errors, based on group properties, may be inserted randomly into the transactions to test the response of the hardware model 124 to such errors. Upon being generated, the transactions 204, 214 may be placed in a group 202, 212 corresponding to the device which generated the respective transactions 204, 214. During subsequent simulation of the generated transactions 204, 214, the respective simulation properties 206, 216 may be used to control processing of the transactions 204, 214 in the simulation environment 114.

At step 306, simulation of the hardware model 124 may be initiated. Then, at step 308, the first group of transactions 204 and the second group of transactions 214 may be issued to the hardware model 124 as described above. At step 310, the first group of transactions 204 and the second group of transactions 214 may be processed using the hardware model 124. In one embodiment, at least a portion of the first group of transactions 204 and the second group of transactions 214 may be processed simultaneously using the hardware model 124. For example, where the hardware model 124 includes several devices or a single device capable of processing multiple transactions simultaneously, the simulation may be used to test reaction of the hardware model 124 to processing of transactions 204, 214 from both the first group and the second group.

At step 312, during processing of the first group of transactions 204 and the second group of transactions 212, the first simulation properties 206 may be used to process the first group of transactions 204 and the second simulation properties 216 may be used to process the second group of transactions 214. For example, the simulation properties 206, 216 may be used to select types of errors injected into transactions 204, 214, types of error checking performed for different transactions 204, 214, and types of error recovery performed for different transactions 204, 214. Such errors may include bus errors, link errors, cyclic redundancy code (CRC) errors, parity errors, and/or other errors. Then, at step 314, results of the simulation may be stored and/or output to a user. Where the results are output to the user, the results may be output, for example, via the simulation interface 122.

As mentioned above, in one embodiment of the invention, simulation properties 206, 216 for transactions 204, 214 in a group 202, 212 may be used to generate transactions 204, 214 in a group 202, 212, determine whether to inject errors into a given transaction, determine what error checking to perform for transactions 204, 214 in a group 202,212, and determine what type of error recovery, if any, to perform for transactions 204, 214 in a group 202, 212. As previously mentioned, by providing different simulation properties 206, 216 for groups of transactions 204, 214, a user of the simulation environment 114 may be able to easily create and manage groups of transactions 204, 214, which, when simulated, provide a complex and comprehensive test of the simulated hardware model 124.

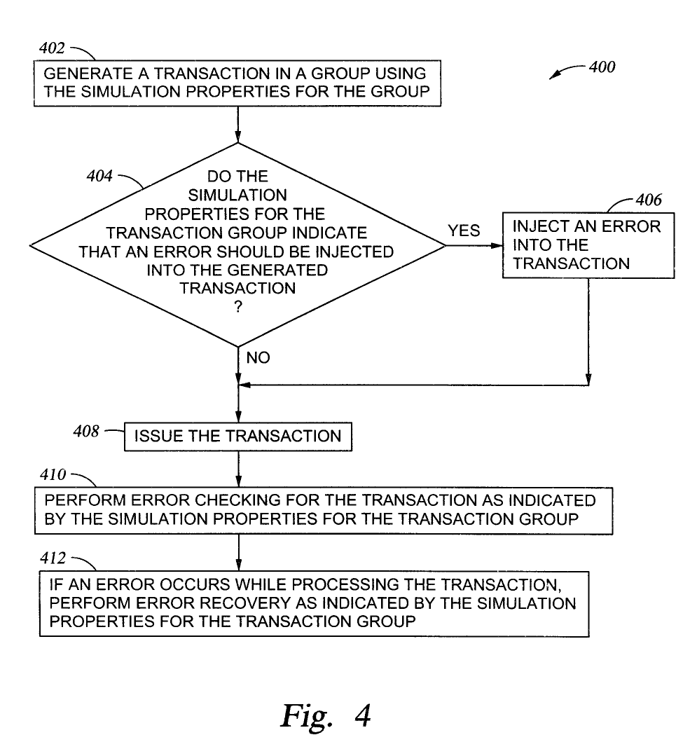

FIG. 4 is a flow diagram depicting a method 400 for using simulation properties to generate and process grouped transactions according to one embodiment of the invention. The process 400 may begin at step 402 where a transaction in a group is generated using the simulation properties for the transaction group. Then, at step 404, a determination may be made of whether the simulation properties for the transaction group indicate that an error should be injected into the generated transaction. If so, an error is injected into the transaction at step 406.

As previously mentioned, in some cases, errors may be injected into a transmission in order to test the response of the hardware model 124 to such errors. In one embodiment, recoverable errors and/or non-recoverable errors may be injected a transmission according to the simulation properties for a group. A recoverable error may be an error where a device in the hardware model 124 is capable of successfully processing a transaction which includes an error. For example, the transaction may include a simulated transmission error which is recoverable via an error correction code (ECC). A nonrecoverable error may be an error where the device in the hardware model 124 is incapable of successfully processing a transaction which includes an error. For example, a simulated transaction (or transactions) may result in a link error which is not recoverable. Another way of injecting errors may be to corrupt the header of a transaction packet.

After a transaction has been generated and an error, if any, has been inserted into the transaction, then the transaction may be issued at step 408. Then, at step 410, error checking for the transaction may be performed as indicated by the simulation properties for the transaction group. For example, in one embodiment, a first type of error checking may be performed for transactions in a first group while the first type of error checking may not be performed for transactions in a second group. Thus, for example, grouped transactions which do not need certain types of error checking (e.g., transactions with non-recoverable errors may not need any check to determine whether the transaction is ultimately placed in a main memory) may not be fully checked for errors while other grouped transactions may be fully error checked to ensure, for example, that data buffers used by the transaction are released and that the transaction is successfully placed in main memory. Another type of error checking which may be performed may be checking to determine whether a transaction has been dropped. In some cases, by performing full checking for transactions in a first group without injected errors, any errors in transactions from the first group caused by simultaneous processing of transactions in a second group (e.g., a group with errors injected) may be detected and corrected.

At step 412, if an error occurs while processing a transaction, error recovery may be performed as indicated by the simulation properties for the transaction group. For example, error recovery may not be performed for some grouped transactions (e.g., grouped transactions resulting in non-recoverable errors) while error recovery may be performed for other grouped transactions (e.g., grouped transactions resulting in recoverable errors). In some cases, simulation properties for a given group may also be applied to error recovery for a device in the group. For example, the simulation properties may be used to determine what types of error recovery a device in a given group should perform.

As previously mentioned, the transaction grouping and simulation properties 206, 216 may be used to control or identify any properties of transactions 204, 214 and/or devices 208, 218 in a given group 202, 212, (e.g., in addition to error injection, checking, and recovery as described with respect to FIG. 4). For example, in one embodiment, transactions 204, 214 may be directed to a main memory model. The transactions 204, 214 may be placed in transaction groups 202, 212 based upon the memory pages of the main memory that they target. Then, during simulation, if a processor instruction is executed which invalidates a page of memory, only transactions in the group corresponding to that page will be affected.

As described above, by placing transactions into groups and manipulating simulation properties of different groups, management of simulated hardware testing may be simplified while providing improved testing complexity. While the foregoing is directed to embodiments of the present invention, other and further embodiments of the invention may be devised without departing from the basic scope thereof, and the scope thereof is determined by the claims that follow.

What is claimed is:

1. A computer-implemented method for simulating a plurality of transactions, the method comprising:
providing a first group of transactions with first simulation properties;
providing a second group of transactions with second simulation properties, wherein the first simulation properties are different from the second simulation properties;
during software simulation of a hardware model:
issuing the first group of transactions and the second group of transactions to the hardware model; and
processing the first group of transactions and the second group of transactions using the hardware model, wherein at least a portion of the first group of transactions and the second group of transactions is processed simultaneously using the hardware model, wherein the first simulation properties are used to process the first group of transactions using the hardware model and wherein the second simulation properties are used to process the second group of transactions using the hardware model.

2. The method of claim 1, wherein the first simulation properties and the second simulation properties control types of errors injected into the first group of transactions and the second group of transactions, and wherein the first simulation properties and the second simulation properties provide different types of error injection for the first group of transactions and the second group of transactions.

3. The method of claim 2, wherein the first simulation properties provide for injection of recoverable errors into the first group of transactions, and wherein the second simulation properties provide for injection of non-recoverable errors into the second group of transactions.

4. The method of claim 1, wherein the first simulation properties and the second simulation properties control types of error checking performed for the first group of transactions and the second group of transactions, and wherein the first simulation properties and the second simulation properties provide different types of error checking for the first group of transactions and the second group of transactions.

5. The method of claim 1, wherein the first simulation properties and the second simulation properties control types of error recovery performed for the first group of transactions and the second group of transactions, and wherein the first simulation properties and the second simulation properties provide different types of error recovery for the first group of transactions and the second group of transactions.

6. The method of claim 1, wherein each transaction comprises a packet to be processed by the hardware model.

7. The method of claim 1, wherein the first group of transactions is grouped with one or more first resources in the hardware model, and wherein the second group of transactions is grouped with one or second resources in the hardware model.

8. The method of claim 1, wherein the first group of transactions and the second group of transactions utilize at least one shared resource in the hardware model.

9. A computer readable storage medium containing a program which, when executed, performs an operation, comprising:
providing a first group of transactions with first simulation properties;
providing a second group of transactions with second simulation properties, wherein the first simulation properties are different from the second simulation properties;
during software simulation of a hardware model:
issuing the first group of transactions and the second group of transactions to the hardware model; and
processing the first group of transactions and the second group of transactions using the hardware model, wherein at least a portion of the first group of transactions and the second group of transactions is processed simultaneously using the hardware model, wherein the first simulation properties are used to process the first group of transactions using the hardware model and wherein the second simulation properties are used to process the second group of transactions using the hardware model.

10. The computer readable storage medium of claim 9, wherein the first simulation properties and the second simulation properties control types of errors injected into the first group of transactions and the second group of transactions, and wherein the first simulation properties and the second simulation properties provide different types of error injection for the first group of transactions and the second group of transactions.

11. The computer readable storage medium of claim 10, wherein the first simulation properties provide for injection of recoverable errors into the first group of transactions, and wherein the second simulation properties provide for injection of non-recoverable errors into the second group of transactions.

12. The computer readable storage medium of claim 9, wherein the first simulation properties and the second simulation properties control types of error checking performed for the first group of transactions and the second group of transactions, and wherein the first simulation properties and the second simulation properties provide different types of error checking for the first group of transactions and the second group of transactions.

13. The computer readable storage medium of claim 9, wherein the first simulation properties and the second simulation properties control types of error recovery performed for the first group of transactions and the second group of transactions, and wherein the first simulation properties and the second simulation properties provide different types of error recovery for the first group of transactions and the second group of transactions.

14. The computer readable storage medium of claim 9, wherein each transaction comprises a packet to be processed by the hardware model.

15. The computer readable storage medium of claim 9, wherein the first group of transactions is grouped with one or more first resources in the hardware model, and wherein the second group of transactions is grouped with one or second resources in the hardware model.

16. The computer readable storage medium of claim 9, wherein the first group of transactions and the second group of transactions utilize at least one shared resource in the hardware model.

17. A system, comprising:
a processor; and
a computer readable storage medium containing a program which, when executed by the processor, performs an operation, comprising:
providing a first group of transactions with first simulation properties;
providing a second group of transactions with second simulation properties, wherein the first simulation properties are different from the second simulation properties;
during software simulation of a hardware model:
issuing the first group of transactions and the second group of transactions to the hardware model; and
processing the first group of transactions and the second group of transactions using the hardware model, wherein at least a portion of the first group of transactions and the second group of transactions is processed simultaneously using the hardware model, wherein the first simulation properties are used to process the first group of transactions using the hardware model and wherein the second simulation properties are used to process the second group of transactions using the hardware model.

18. The system of claim 17, wherein the first simulation properties and the second simulation properties control types of errors injected into the first group of transactions and the second group of transactions, and wherein the first simulation properties and the second simulation properties provide different types of error injection for the first group of transactions and the second group of transactions.

19. The system of claim 18, wherein the first simulation properties provide for injection of recoverable errors into the first group of transactions, and wherein the second simulation properties provide for injection of non-recoverable errors into the second group of transactions.

20. The system of claim 17, wherein the first simulation properties and the second simulation properties control types of error checking performed for the first group of transactions and the second group of transactions, and wherein the first simulation properties and the second simulation properties provide different types of error checking for the first group of transactions and the second group of transactions.

21. The system of claim 17, wherein the first simulation properties and the second simulation properties control types of error recovery performed for the first group of transactions and the second group of transactions, and wherein the first simulation properties and the second simulation properties provide different types of error recovery for the first group of transactions and the second group of transactions.

22. The system of claim 17, wherein each transaction comprises a packet to be processed by the hardware model.

23. The system of claim 17, wherein the first group of transactions is grouped with one or more first resources in the hardware model, and wherein the second group of transactions is grouped with one or second resources in the hardware model.

24. The system of claim 17, wherein the first group of transactions and the second group of transactions utilize at least one shared resource in the hardware model.
